(19) United States
(12) Patent Application Publication
(10) Pub. No.: US 2024/0268340 A1
(43) Pub. Date: Aug. 15, 2024

(54) SLOW DOG FEEDER

(71) Applicant: Bobby J Benish, Bedford, IN (US)

(72) Inventor: Bobby J Benish, Bedford, IN (US)

(21) Appl. No.: 18/109,467

(22) Filed: Feb. 14, 2023

(51) Int. Cl. A01K 5/01

(52) U.S. Cl. CPC A01K 5/0135

(57) ABSTRACT

A slow dog feeder includes a dishwasher safe body that has at least two distinct food support areas that each have a pattern of slow food protrusion obstacles extending vertically upward from the respective food support area. Each of the food support areas is encircled by a separate enclosure wall that terminates at a respective rim. One of the food support areas is at a position above the rim of another one of the food support areas along a vertical line.

### TECHNICAL FIELD

The present disclosure relates generally to dog feeding equipment, and more particularly to an apparatus that tends to prolong a dog's eating experience.

### BACKGROUND

Pet owners know that many dog breeds tend to eat too much too fast, which can lead to painful, unhealthy, and potentially dangerous food bloat. Food bloat is a condition in which a dog's stomach becomes over-filled and distended. In some instances, food bloat can lead to dehydration, pancreatitis, and even potentially deadly gastric dilation and volvulus. Surprisingly, bloat is apparently second only to cancer as a cause of death in dogs. In an effort to prevent food bloat, the pet feeding industry has developed a variety of slow feeding dog bowls that include a pattern of protrusion obstacles that force the dog to search among the obstacles in the bowl to retrieve and eat the food therein. This strategy has proven effective in many cases, but the problems continue. Other pet owners have tried to address food bloating by elevating the dog's bowl during feeding. Unfortunately, a study on bloating performed by Purdue University in the 1990's showed that bowl elevation actually exacerbated food bloating. Thus, dangerous food bloating continues to occur, and there remains room for improvement.

The present disclosure is directed toward one or more of the problems set forth above.

### SUMMARY OF THE DISCLOSURE

In one aspect, a slow dog feeder includes a dishwasher safe body having a floor contact surface that lies in a plane. The dishwasher safe body includes a first feeding location that is distinct from a second feeding location, which has a fixed orientation and position with respect to the first feeding location. The first feeding location includes a first pattern of slow food protrusion obstacles extending away from the plane in a first food support area, and the second feeding location includes a second pattern of slow food protrusion obstacles extending away from the plane in a second food support area. The first food support area is bound by a first enclosure wall, and the second food support area is bound by a second enclosure wall. A majority of the first enclosure wall terminates at a first rim, and a majority of the second enclosure wall terminates at a second rim. The first food support area is at a position above the second rim along a line perpendicular to the plane.

In another aspect, the slow dog feeder includes a third feeding location with a third pattern of slow food protrusion obstacles extending away from the plane in a third food support area, which is bound by a third enclosure wall that terminates at a third rim. The first food support area is at a position above both of the second rim and the third rim along a line perpendicular to the plane. The dishwasher safe body has an outer perimeter with exactly zero exposed downwardly oriented nose engagement surfaces that could be used to overturn the slow dog feeder, and the floor contact surface defines a closed figure. The dishwasher safe body has a length dimension, a width dimension and a height dimension that is smaller than both the width dimension and the length dimension to promote stability.

In still another aspect, a method of prolonging a feeding experience of a dog includes placing the slow dog feeder at a location accessible to the dog. A first fraction of a food serving is positioned onto the first food support area, and a second fraction of the food serving is positioned onto the second food support area of the slow dog feeder.

### BRIEF DESCRIPTION OF THE DRAWINGS

FIG. 1 is a sectioned front view of a slow dog feeder according to the present disclosure as viewed along section line 1-1 of FIG. 2;

FIG. 2 is a top view of the slow dog feeder of FIG. 1;

FIG. 3 is a bottom view of the slow dog feeder of FIGS. 1-2;

FIG. 4 is a perspective view of the slow dog feeder of FIGS. 1-3;

FIG. 5 is a top view of slow dog feeder according to another embodiment of the present disclosure;

FIG. 6 is a front view of the slow dog feeder of FIG. 5;

FIG. 7 is a perspective view of the slow dog feeder of FIGS. 5 and 6;

FIG. 8 is a perspective view of the slow dog feeder according to another embodiment of the present disclosure;

FIG. 9 is a top view of the slow dog feeder of FIG. 8;

FIG. 10 is a top view of the slow dog feeder according to another embodiment of the present disclosure;

FIG. 11 is a perspective view of the slow dog feeder of FIG. 10;

FIG. 12 is a top view of a slow dog feeder according to another embodiment of the present disclosure;

FIG. 13 is a perspective view of the slow dog feeder of FIG. 12;

FIG. 14 is a perspective view of a slow dog feeder according to still another embodiment of the present disclosure;

FIG. 15 is a top view of the slow dog feeder of FIG. 14;

FIG. 16 is a top view of a slow dog feeder according to another embodiment of the present disclosure;

FIG. 17 is a perspective view of the slow dog feeder of FIG. 17;

FIG. 18 is a top view of the slow dog feeder according to another embodiment of the present disclosure;

FIG. 19 is a perspective view of the slow dog feeder of FIG. 18;

FIG. 20 is a perspective view of a slow dog feeder according to another embodiment of the present disclosure;

FIG. 21 is a top view of a slow dog feeder of FIG. 20;

FIG. 22 is a top view of a slow dog feeder according to still another embodiment of the present disclosure;

FIG. 23 is a perspective view of the slow dog feeder of FIG. 22;

FIG. 24 is a top view of a slow dog feeder according to another embodiment of the present disclosure;

FIG. 25 is a perspective view of the slow dog feeder of FIG. 24;

FIG. 26 is a perspective view of a slow dog feeder according to another embodiment of the present disclosure;

FIG. 27 is a top view of the slow dog feeder of FIG. 26;

FIG. 28 is a top view of a slow dog feeder according to another aspect of the present disclosure;

FIG. 29 is a perspective view of the slow dog feeder of FIG. 28;

FIG. 30 is a top view of a slow dog feeder according to another embodiment of the present disclosure;

FIG. 31 is a perspective view of the slow dog feeder of FIG. 30;

FIG. 32 is a front sectioned view of a slow dog feeder according to another aspect of the present disclosure as viewed along section line 32-32 of FIG. 33;

FIG. 33 is a top view of the slow dog feeder of FIG. 32;

FIG. 34 is a front sectioned view of a slow dog feeder according to still another aspect of the present disclosure; and

FIG. 35 is a sectioned from view of a slow dog feeder according to another aspect of the present disclosure.

### DETAILED DESCRIPTION

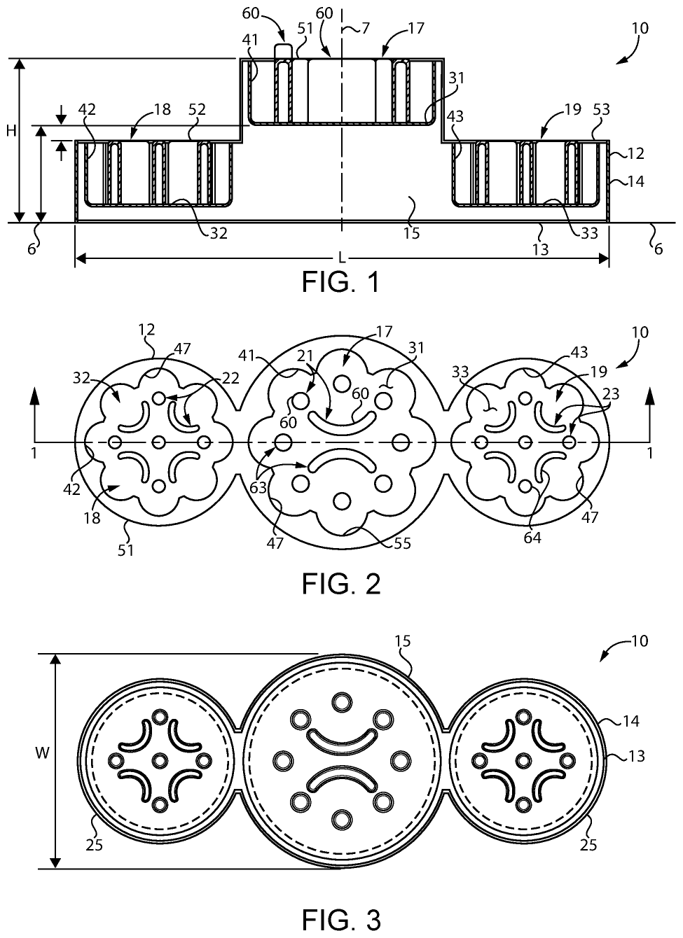

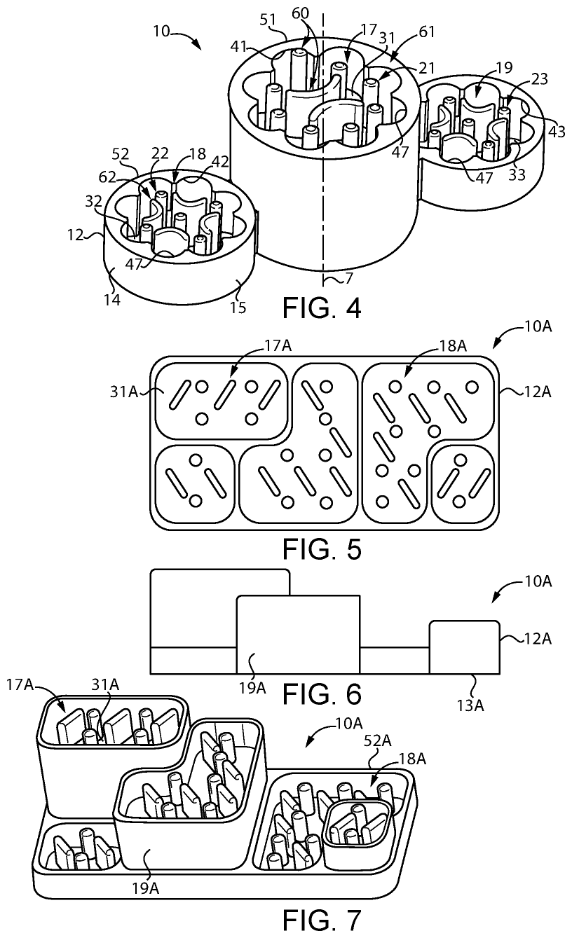

Referring initially to FIGS. 1-4, a preferred embodiment of a slow dog feeder 10 includes a dishwasher safe body 12 with a floor contact surface 13 that lies in a plane 6. In the context of the present disclosure, “dishwasher safe body” means an inseparable unit that is sized to fit in a residential dishwasher (L× W× H, no dimension greater than 20 inches) and survive a dishwasher cycle without melting or otherwise degrading. Dishwasher safe body 12 may be formed from a unitary piece of molded plastic 14, formed from a single sheet of stainless steel, or manufactured from any suitable material(s) known in the art. In order to promote stability, the height dimension H of the dishwasher safe body 12 may be less than both the width dimension W and the length dimension L. The floor contact surface 13 may define a closed FIG. 25 in order to hinder the ability of the feeding dog to upend the slow dog feeder 10. Further in this regard, an outer perimeter 15 of the slow dog feeder 10 preferably has exactly zero exposed downwardly oriented nose engagement surfaces that could be used to overturn the slow dog feeder 10.

While all versions of a slow dog feeder according to the present disclosure have at least two distinct feeding locations, the embodiment of FIGS. 1-4 includes three feeding locations. In particular, the dishwasher safe body 12 includes a first feeding location 17 that is distinct from a second feeding location 18, which are both distinct from a third feeding location 19. In the context of the present disclosure, two feeding locations are distinct from each other if there is a vertical enclosure wall segment positioned between the two feeding locations. All three feeding locations 17, 18 and 19 have fixed orientations and positions relative to each other. The first feeding location 17 includes a first pattern of slow food protrusion obstacles 21 extending away from the plane 6 in a first food support area 31, the second feeding location 18 includes a second pattern of slow food protrusion obstacles 22 that extend away from the plane 6 in a second food support area 32, and the third feeding location 19 that includes a third pattern of slow food protrusion obstacles 23 that also extend away from the plane in a third food support area 33. Pattern 21 is different from patterns 22 and 23, which may be identical to each other. As best seen in the first food support area 17, a plurality of food support obstacles 60 may have different vertical heights and still be parts of the first pattern of pattern of slow food protrusion obstacles 21. As best seen if FIG. 2, the pattern 21 may include obstacles 63 that have different shapes such as an arc and a circle. Also, the pattern may include obstacles 64 that have different cross sectional areas. Thus, there may be two or more different heights, shapes and cross sectional areas of obstacles in each pattern, or all of the obstacles could have the same heights or shapes or sizes without departing from the present disclosure.

The first food support area 31 is bound by a first enclosure wall 41, the second food support area 32 is bound by a second enclosure wall 42, and the third food support area is bound by a third enclosure wall 43. A majority of the first enclosure wall 41 terminates at a first rim 51, which in this example is a closed figure rim 55. A majority of each of the second enclosure wall 42 and the third enclosure wall 43 terminate at a second rim 52 and third rim 53, respectively. The first food support area 31 is at a position above the second rim 52 along a line 7 that is perpendicular to the plane 6. In this embodiment, the geometry and features of the second and third feeding locations 18 and 19 may be identical to each other and flank opposite sides of the first feeding location 17. Thus, the first food support area 31 is also positioned above the third rim 53.

The first food support area 31 and the first enclosure wall 41 define a first dish 61 with a first capacity, which is less than it could be due to the presence of the first pattern of slow food protrusion obstacles 21. The second food support area 32 and the second enclosure wall 42 define a second dish 62 with a second capacity that is about equal to the first capacity. As used in this disclosure, the term “about equal” means that a ratio of the two quantities is one when rounded to the nearest integer. Although they could be the same, the first pattern of slow food protrusion obstacles 21 is different from the second pattern of slow food protrusion obstacles 22, which may be identical to the third pattern of slow food protrusion obstacles 23. The differences can include one or more of differences in a number of obstacles, height of the obstacles or even shape of one or more obstacles. Preferably, all of the food protrusion obstacles are between one inch and three and one half inches tall when measured from the respective food support area. Although not necessary the first enclosure wall 41 may be defined by a plurality of scallop shaped wall segments 47, which may also be present in the second and third wall enclosures 42 and 43.

Referring now to the remaining figures, various embodiments of a slow dog feeder are illustrated. All include at least two food support areas that are at different heights while also including an array of slow food protrusion obstacles. Many of the feature numbers introduced in relation to the embodiment of FIGS. 1-4 are repeated below with an added letter designation to represent identical features in the other illustrated embodiments. For instance, FIGS. 5-7 show a slow dog feeder 10A with a dishwasher safe body 12A that defines five distinct feeding locations generally arranged in a rectangular foot print. A first feeding location 17A includes a first food support area 31A that is positioned above a rim 52A of a second feeding location 18A. A third feeding location 19A is positioned at a height between the first and second feeding locations 17A and 18A. Each of the five feeding locations include individual patterns of food protrusion obstacles that include two different shapes.

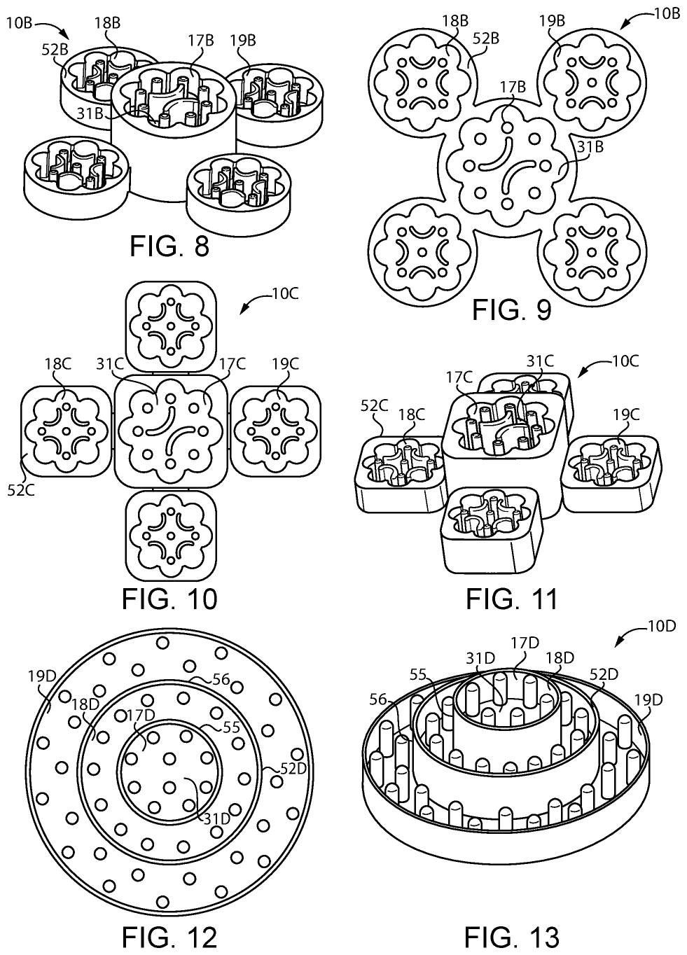

FIGS. 8 and 9 show an example embodiment similar to FIG. 1, except including five distinct feeding location versus the three feeding locations of the FIGS. 1-4 embodiment. Slow dog feeder 10B includes a first feeding location 17B, a distinct second feeding location 18B and a third feeding location 19B, and two un-numbered additional feeding locations. Like the earlier embodiments, the first food support area 31B is positioned vertically above the rim 52B associated with the second feeding location 18B. FIGS. 10 and 11 show a similar embodiment of a slow dog feeder 10C, except the feeding locations define a generally square shape versus the circular shapes of FIGS. 8 and 9. Like the earlier embodiments, the first feeding location 17C has a food support area 31C that is positioned above rim 52C of the second feeding location 18C. The third feeding location 19C and the two remaining un-numbered feeding locations may all be substantially identical to second feeding location 18C.

FIGS. 12 and 13 show a slow dog feeder 10D that includes three concentric and distinct feeding locations 17D, 18D and 19D. Like the earlier embodiments, the food support area 31D of first feeding location 17D is positioned above rim 52D of second feeding location 18D along a vertical line. Unlike the previous embodiments slow dog feeder 10D includes a first closed figure rim 55 and a second closed figure rim 56, which encircles closed figure rim 55. In the case of the embodiment of FIGS. 1-4, first rim 51 defines a closed figure, but the rim 52 may be thought of as defining an open figure that is open due to a lack of a rim where the two feeding locations 17 and 18 are adjacent each other. The slow dog feeder 10D is also of interest for showing an example where all of the food protrusion obstacles are identical.

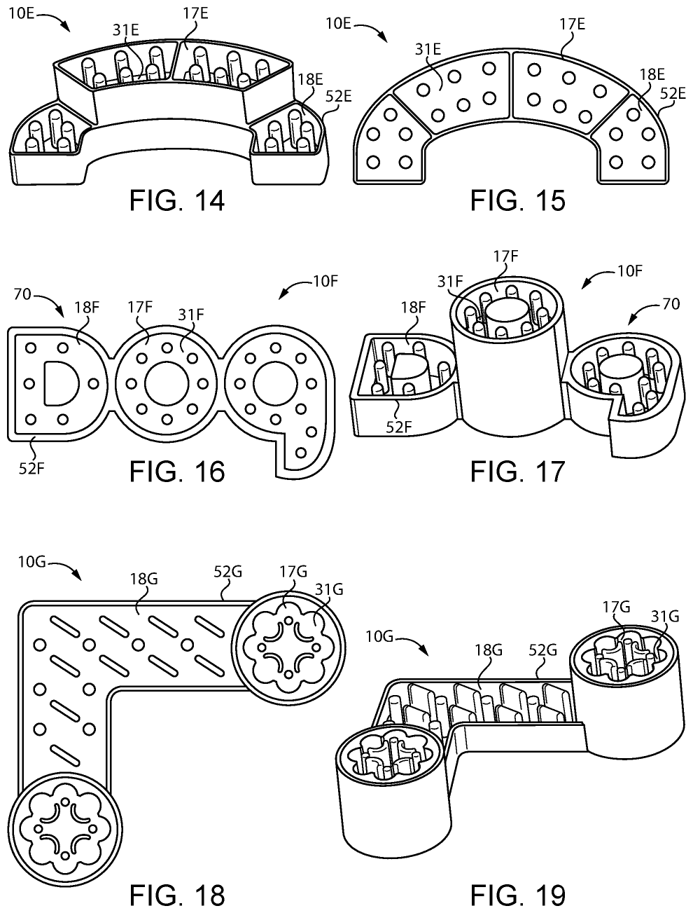

FIGS. 14 and 15 show another slow dog feeder 10E that includes four distinct feeding locations, which includes a first feeding location 17E and a second feeding location 18E. The food support area 31E of feeding location 17E is positioned above a rim 52E of feeding location 18E along a vertical line. like the earlier embodiments, all the four feeding locations include separate patterns of slow food protrusion obstacles, which are shown as vertical cylindrical columns. The overall slow dog feeder 10E has an arc shape.

The embodiments of FIGS. 16-17 and 24-25 are of interest for showing respective slow dog feeders 10F and 10J with dishwasher safe bodies 12F and 12J having a plurality of surfaces that together define and spell a word 70. While any word could fall within the scope of this disclosure, the illustrated embodiments spell out the respective words of “Dog” and “EAT”. Thus, each embodiment has three distinct feeding locations corresponding to the respective letters of the word 70. The “o” in “Dog” defines a first feeding location 17F with a food support area 31F that is positioned above a rim 52F of a second feeding location 18F, which is associated with the letter “D”. Likewise, the “A” in “EAT” defines a first feeding location 17J with a food support area 31J that is above a rim 52J of a second feeding location 18J associated with the letter “T”. All of the feeding locations in both embodiments include respective patterns of slow food protrusion obstacles.

The embodiment of FIGS. 18 and 19 is of interest for showing a slow dog feeder 10G with three feeding locations arranged in a generally “L” shape. Like the earlier embodiments, a first feeding location 17G has a food support area 31G that is above a rim 52G of a second feeding location 18G. The enclosure wall of the first feeding location includes scalloped wall segments but the second feeding location 18G includes no scalloping in its enclosure wall. Also the patterns of slow food protrusion obstacles in the first and second feeding locations 17G and 18G are distinctly different in the shapes and sizes of the various protrusion obstacles.

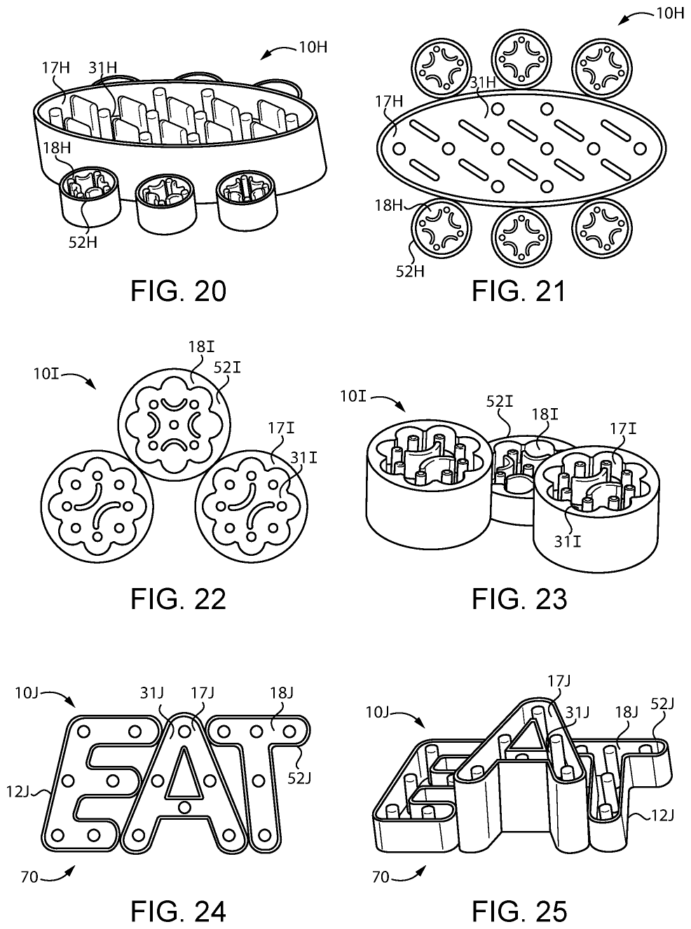

The embodiment of FIGS. 20-21 shows a slow dog feeder 10H with seven distinct feeding locations that includes one large elevated oval and six small circles. The slow dog feeder specifically includes a first feeding location 17H with a food support area 31H that is above a rim of 52H of a second feeding location 18H that is identical to the other five circular feeding locations. The six small circular feeding locations include identical patterns of slow food protrusion obstacles, which are different from the pattern of slow food protrusion obstacles associated with the first feeding location 17H.

The embodiment of FIGS. 22 and 23 shows a slow dog feeder 10I with three circular feeding locations. A first feeding location 17I has a food support area 31I that is above a rim 521 of a second feeding location 18I. This embodiment also shows enclosure walls with scallop shaped wall segments, and two different patterns of slow food protrusion obstacles.

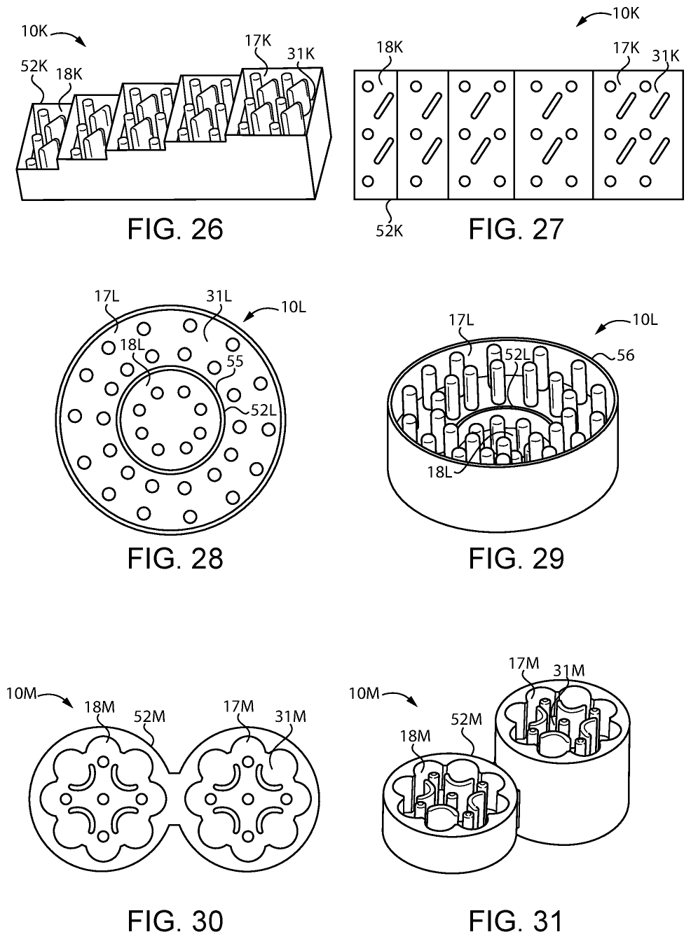

The embodiment of FIGS. 26 and 27 shows a slow dog feeder 10K with a rectangular foot print that defines five smaller rectangular feeding locations that stair step upward in elevation from left to right. Among these is a first feeding location 17K that has a food support area 31K that is above a rim 52K of a second feeding location 18K. All the feeding locations include similar patterns of slow food protrusion obstacles.

The embodiment of FIGS. 28 and 29 is similar to the embodiment of FIGS. 12 and 13, except having the elevated food support area is located at the periphery as opposed to the center. This embodiment also includes an outer closed figure rim 56 that encircles an inner closed figure rim 55 as in the previous embodiment. The first food support area 17L of the slow dog feeder 10L has a food support area 31L that is above a rim 52L that encloses a second feeding location 18L. Both feeding locations include different patterns of identical slow food protrusion obstacles.

The embodiment of FIGS. 30 and 31 is of interest for showing a slow dog feeder 10M with exactly two feeding locations 17M and 18M that have about the same capacity and identical patterns of slow food protrusion obstacles. The first feeding location 17M has a food support area 31M that is positioned above a rim 52M of the second feeding location 18M.

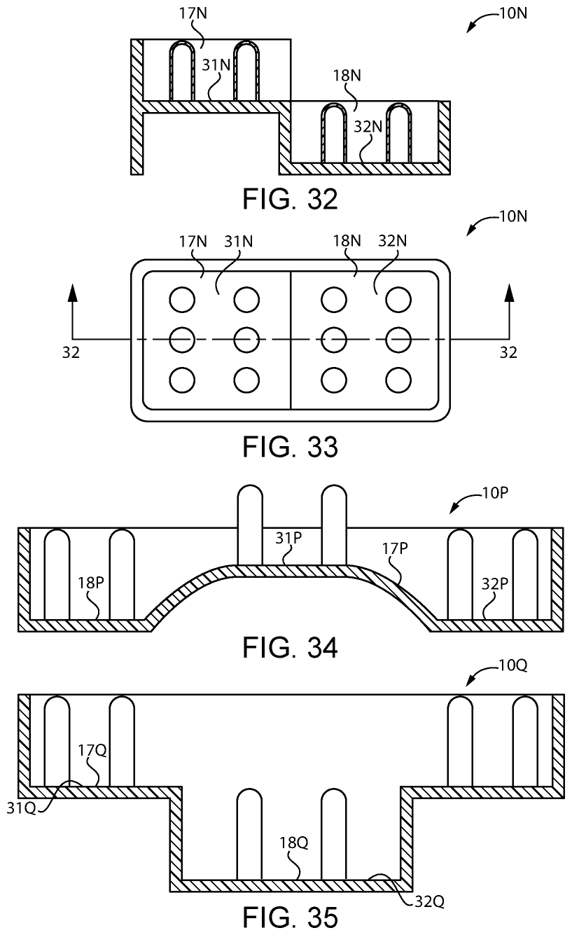

The embodiment of FIGS. 32 and 33 is of interest for showing a slow dog feeder 10N with a food support are that is not bound by an enclosure wall. In particular, first feeding location 17N has a first food support are 31 N that is not bound by an enclosure wall adjacent the second feeding location 18N, which includes a food support area 32N that is below the first food support area. Thus, food originally placed on the first food support area 31N can spill over onto the second food support are due to the lack of an enclosure wall separating the two feeding locations 17N and 18N. Both Feeding locations may include identical simple patterns of slow food protrusion obstacles as shown, or could be completely different without departing from the scope of this disclosure.

The embodiment of FIG. 34 shows a section view through a slow dog feeder 10P with a first feeding location 17P with an elevated food support area 31P that is completely unbound by any enclosure wall with respect to second feeding location 18P, which has a second food support area 32P that is at a lower position relative to first food support area 31P.

The embodiment of FIG. 35 is similar to that of FIGS. 28 and 29, except that no enclosure wall separates the first elevated food support area 31Q of the first feeding location 17Q from the lower food support area 32Q of the second feeding location 18Q.

### INDUSTRIAL APPLICABILITY

The present disclosure finds potential application in any dog feeding situation, especially in relation to breeds that tend to eat too fast and risk bloat. Any of the slow dog feeders 10 described above may be used by positioning a first fraction of a food serving onto the first food support area 31, and a second or remaining fraction of the food serving onto the second food support area 32. The slow dog feeder 10 is placed at a location accessible to the dog. Testing has shown that by positioning the two or more portions of the food serving at distinct feeding locations 17 and 18 that are different elevations tends to slow the dog feeding period by several minutes over conventional slow dog feeders that include only one feeding location and no significant elevation changes. This advantage of the slow dog feeders according to this disclosure further reduces the risk of dangerous bloating over prior art dog feeders and dog feeding strategies.

The present description is for illustrative purposes only, and should not be construed to narrow the breadth of the present disclosure in any way. Thus, those skilled in the art will appreciate that various modification might be made to the presently disclosed embodiments without departing from the full and fair scope and spirit of the present disclosure. Other aspects, features and advantages will be apparent upon an examination of the attached drawings and appended claims.

What is claimed is:

1. A slow dog feeder comprising
a dishwasher safe body having a floor contact surface that lies in a plane;
the dishwasher safe body including a first feeding location distinct from a second feeding location, which has a fixed orientation and position with respect to the first feeding location;
the first feeding location including a first pattern of slow food protrusion obstacles extending away from the plane in a first food support area, and the second feeding location including a second pattern of slow food protrusion obstacles extending away from the plane in a second food support area;
the first food support area is bound by a first enclosure wall, and the second food support area is bound by a second enclosure wall;
a majority of the first enclosure wall terminating at a first rim, and a majority of the second enclosure wall terminating at a second rim; and
the first food support area being at a position above the second rim along a line perpendicular to the plane.

2. The slow dog feeder of claim 1 wherein the dishwasher safe body includes a third feeding location that is distinct from both the first feeding location and the second feeding location.

3. The slow dog feeder of claim 1 wherein the first food support area and the first enclosure wall define a first dish with a first capacity; and
the second food support area and second enclosure wall define a second dish with a second capacity that is about equal to the first capacity.

4. The slow dog feeder of claim 1 wherein the first pattern of slow food protrusion obstacles is different from the second pattern of slow food protrusion obstacles.

5. The slow dog feeder of claim 1 wherein at least one of the first enclosure wall and the second enclosure wall is defined by a plurality of scallop shaped wall segments.

6. The slow dog feeder of claim 1 wherein the dishwasher safe body is a dishwasher safe unitary piece of molded plastic.

7. The slow dog feeder of claim 1 wherein at least one of the first pattern of slow food protrusion obstacles and the second pattern of slow food protrusion obstacles includes a plurality of food protrusion obstacles that terminate at different heights along a line perpendicular to the plane.

8. The slow dog feeder of claim 1 wherein at least one of the first pattern of slow food protrusion obstacles and the second pattern of slow food protrusion obstacles includes a plurality of food protrusion obstacles having different shapes.

9. The slow dog feeder of claim 1 wherein at least one of the first pattern of slow food protrusion obstacles and the second pattern of slow food protrusion obstacles includes a plurality of food protrusion obstacles having different cross sectional areas.

10. The slow dog feeder of claim 1 wherein every food protrusion obstacle of the first pattern of slow food protrusion obstacles and the second pattern of slow food protrusion obstacles is between one inch and three and one half inches tall.

11. The slow dog feeder of claim 1 wherein the dishwasher safe body has an outer perimeter with exactly zero exposed downwardly oriented nose engagement surfaces that could be used to overturn the slow dog feeder.

12. The slow dog feeder of claim 1 wherein the floor contact surface defines a closed figure.

13. The slow dog feeder of claim 1 wherein the dishwasher safe body has a length dimension, a width dimension and a height dimension;
the height dimension is smaller than both the width dimension and the length dimension to promote stability.

14. The slow dog feeder of claim 1 wherein the dishwasher safe body has a length dimension, a width dimension and a height dimension that are all less than twenty inches.

15. The slow dog feeder of claim 1 wherein the first rim is a first closed figure rim, and the second rim is a second closed figure rim; and
one of the first closed figure rim and the second closed figure rim encircles the other one of the first closed figure rim and the second closed figure rim.

16. The slow dog feeder of claim 1 wherein the dishwasher safe body includes a plurality of surfaces that together define and spell a word.

17. A slow dog feeder comprising
a dishwasher safe body that is a unitary piece of molded plastic having a floor contact surface that lies in a plane and defines a closed figure;
the dishwasher safe body including a first feeding location flanked on opposite sides by a second feeding location and a third feeding location;
the first feeding location including a first pattern of slow food protrusion obstacles extending away from the plane in a first food support area, the second feeding location including a second pattern of slow food protrusion obstacles extending away from the plane in a second food support area, and the third feeding location including a third pattern of slow food protrusion obstacles extending away from the plane in a third food support area;
the first food support area is bound by a first enclosure wall that terminates at a first closed figure rim, the second food support area is a bound by a second enclosure wall, and the third food support area is bound by a third enclosure wall;
a majority of the second enclosure wall terminating at a second rim, and a majority of the third enclosure wall terminating at a third rim;
the first food support area being at a position above both of the second rim and the third rim along a line perpendicular to the plane;
the dishwasher safe body has an outer perimeter with exactly zero exposed downwardly oriented nose engagement surfaces that could be used to overturn the slow dog feeder; and
the dishwasher safe body has a length dimension, a width dimension and a height dimension that is smaller than both the width dimension and the length dimension to promote stability.

18. The slow dog feeder of claim 17 wherein at least one of the first enclosure wall, the second enclosure wall and the third enclosure wall is defined by a plurality of scallop shaped wall segments.

19. A method of prolonging a feeding experience of a dog with a slow dog feeder that includes a dishwasher safe body having a floor contact surface that lies in a plane; the dishwasher safe body including a first feeding location distinct from a second feeding location; the first feeding location including a first pattern of slow food protrusion obstacles extending away from the plane in a first food support area, and the second feeding location including a second pattern of slow food protrusion obstacles extending away from the plane in a second food support area; the first food support area is bound by a first enclosure wall, and the second food support area is bound by a second enclosure wall; a majority of the first enclosure wall terminating at a first rim, and a majority of the second enclosure wall terminating at a second rim; the first food support area being at a position above the second rim along a line perpendicular to the plane; and the first dish has a fixed orientation and position with respect to the second dish, the method comprising the steps of:
positioning a first fraction of a food serving onto the first food support area and a second fraction of the food serving onto the second food support area; and
placing the slow dog feeder at a location accessible to the dog.
